(19) United States
(12) Patent Application Publication
(10) Pub. No.: US 2004/0132506 A1
(43) Pub. Date: Jul. 8, 2004

(54) Portable communication device for single hand use

(75) Inventors: Stephen C. Jacobsen, Salt Lake City, UT (US); Fraser Smith, Salt Lake City, UT (US)

Correspondence Address: THORPE NORTH & WESTERN, LLP, P.O. Box 1219, SANDY, UT, 84091-1219, US

(73) Assignee: Sarcos Investments LC.

(21) Appl. No.: 10/680,563

(22) Filed: Oct. 7, 2003

Related U.S. Application Data
(60) Provisional application No. 60/416,896, filed on Oct. 7, 2002.

(51) Int. Cl. H04M 1/00; H04B 1/38

(52) U.S. Cl. 455/575.1; 455/566

(57) ABSTRACT

A portable communication device includes a housing, a communications processor, a speaker and transducer, a viewable display, and a data entry keypad. A communications processor is able to receive and transmit a communication signal, and may be further coupled to an antenna. The speaker and transducer work together to provide communications for the user through the communication device where the transducer receives an audio input for transmission. The viewable display communicates information processed by the communications processor. The data entry keypad is positioned in a location above the video display on the housing and is coupled to the communications transceiver to allow single hand use and manipulation of the data entry keypad such that operation of the keypad does not obstruct the view of the display during operation.

This application claims the benefit of U.S. Provisional Patent Application No. 60/416,896, filed Oct. 7, 2002.

### FIELD OF THE INVENTION

The present invention relates generally to portable communication devices having displays and, more particularly, the present invention relates to a portable communication device that optimizes the ability to enter data via a keypad while preserving viewing of the display during data entry.

### BACKGROUND OF THE INVENTION

Portable telephones, such as cordless phones and cellular phones, have become very popular over the past several years. Originally, the electronics that were within a portable phone were bulky and required a large handset to house such electronics. The displays were placed above the keypads used to dial in information using DTMF (dual tone multi frequency). Further, the displays typically only had a single line of text to view. Because of the size and bulk of these original portable phones, the user typically used both hands, one to hold the phone while the other was used to press the keypad. As keys were pressed, the information such as the number being pressed would be displayed on the display to confirm that the user was entering the correct phone number and the single display line was easy to view.

As portable phones have become smaller due to the size reduction of the electronics inside, they have come to fit comfortably in the user's hand and are able to be operated single handedly. While being held in the palm, the user often uses his or her thumb to press the keys. Unfortunately, the current size of even the average portable phone, let alone the smaller ones, has made it awkward to hold the phone and key in information single handedly. For example, when the user is outside, such as in the user's vehicle, it can be awkward to operate the portable phone or cell phone, view the display, and operate the vehicle at the same time. Although it is highly recommended that the user pull to the side of the road and stop the vehicle while answering a call on the portable phone or placing such a call, often the user is not able to take the time to pull to the side and continues to operate the phone while driving.

### SUMMARY OF THE INVENTION

It has been recognized that it would be advantageous to provide a portable phone that is more easily manageable within one hand, especially so the portable phone user can maintain at least one hand on the steering wheel while driving. Further, it would be advantageous if the portable phone were configured so that manipulation of the phone would be easier, and thereby safer, when operated by the user.

The present invention relates to a method and apparatus for providing a portable communication device. The communication device includes a housing, a communications processor, a display and a keypad. The housing includes an operating surface and an upright phone operating position. The communications processor is disposed in the housing and is operable to receive and transmit a communications signal. The display is coupled to the communications processor and is positioned nearer a lower portion of the operating surface than an upper portion of the operating surface with the housing disposed in the upright phone operating position. The keypad is coupled to the communications processor and is positioned above the display nearer the upper portion of the operating surface than the lower portion of the operating surface.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

While the specification concludes with claims particularly pointing out and distinctly claiming that which is regarded as the present invention, the advantages of this invention may be ascertained from the following description of the invention when read in conjunction with the accompanying drawings, in which:

FIG. 1 illustrates a front view of a portable communication device, depicting the portable communication device having a keypad positioned above a display, according to an embodiment of the present invention;

FIG. 1A illustrates a profile side view of the portable communication device; and

FIG. 2 illustrates a blocked diagram of the portable communication device, according to an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

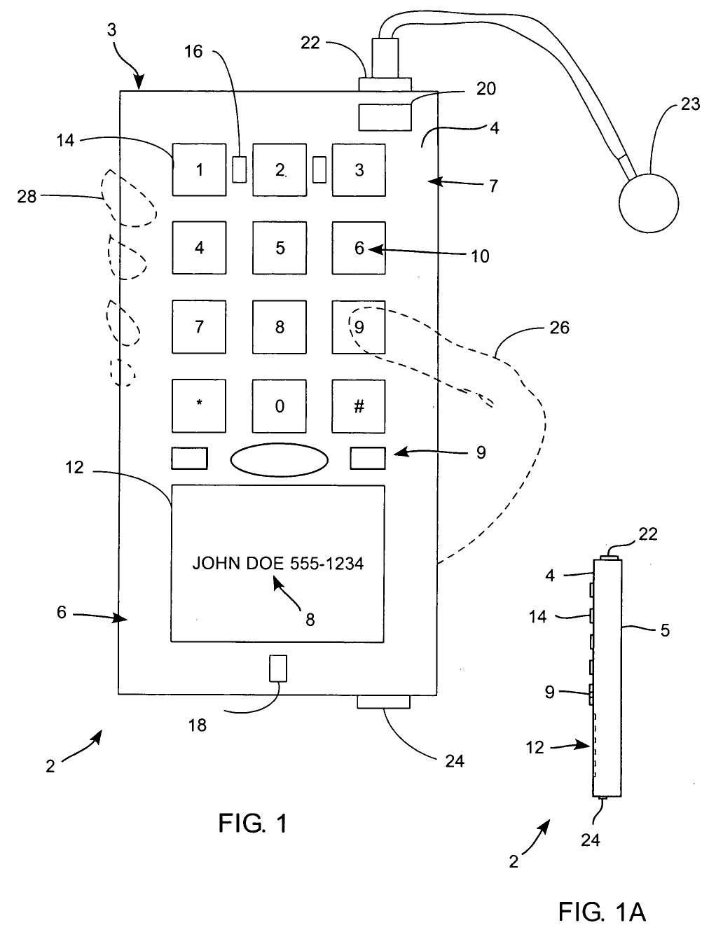

FIGS. 1 and 1A illustrate a portable communication device 2. The communication device 2 is configured for comfortable, single-hand use with a configuration improving the safety and ergonomics while operating the communication device. Such a communication device 2 can be any suitable communication device, such as a portable phone and a mobile phone, or any suitable type of cordless or wireless phone. The communication device can also include communication transmitter devices, such as portable radios, walkie-talkies, personal digital assistant, or any other suitable portable communication device known in the art.

The communication device 2 can include a housing 3 having an operating surface 4 and a back side 5. The operating surface 4 can include a lower portion 6 and an upper portion 7 with a display 12 positioned nearer the lower portion 6 than the upper portion 7 and a keypad 14 positioned above the display 12 nearer the upper portion 7 than the lower portion 6 when the communication device 2 is held in an upright orientation or an upright phone operating position. Upright phone operating position refers to use of the device 2 in an appropriate orientation, with indicia readable in the appropriate upright orientation. The display 12 can be any suitable display known in the art, such as an LCD display, touch-sensitive display and video display. The display 12 can be configured to display readable indicia 8 in an upright orientation in the form of data and/or images. The upright orientation refers to the normal readable orientation of the indicia 8. The keypad 14 can include keys with an alpha-numeric keypad arrangement as well as function keys 9. Each of the keys of the keypad 14 can include indicia 10 disposed in an upright orientation thereon to identify the specific keys in the keypad 14.

The communication device 2 can also include a speaker 16 and a microphone or transducer 18 positioned near of operable through the operating surface 2. The speaker 16 can be positioned at the upper portion 7 of the operating surface 4 adjacent the keypad 14 close to where a user's ear is when held to the user's head. The transducer 18 can be positioned adjacent the display 12 at the lower portion 6 of the operating surface 4 or at a bottom of the housing 3 to enable the user to speak clearly into the communication device 2.

The communication device 2 further includes an on/off switch 20, an external jack 22, in which an earpiece 23 can connect, and a power connector or jack 24. The communication device 2 typically can be powered either by a direct connection power adapter connected through connector 24 or by rechargeable or disposable batteries disposed in the housing. The adapter would also function to recharge the batteries when in a recharge mode.

With the display 12 positioned below the keypad 14 on the operating surface 4, a user can hold the communication device with all four fingers 28 (shown in outline) around a back side 5 of the housing 3 with the thumb 26 (shown in outline) comfortably disposed over the keypad 14 to enter data within the communication device 2. The user is therefore able to firmly grip the housing 3 while using an opposing digit or thumb 26 to manipulate the keypad 14 while also keeping a clear view of the display 12 during a data entry sequence. This provides for a safer operating configuration than that of the prior art since the weight of the communication device 2 is held securely in the user's palm and no distractions are created by the user's fingers or thumb crossing over the screen or the device becoming awkward so as to slip out of the user's hand while entering a data entry sequence.

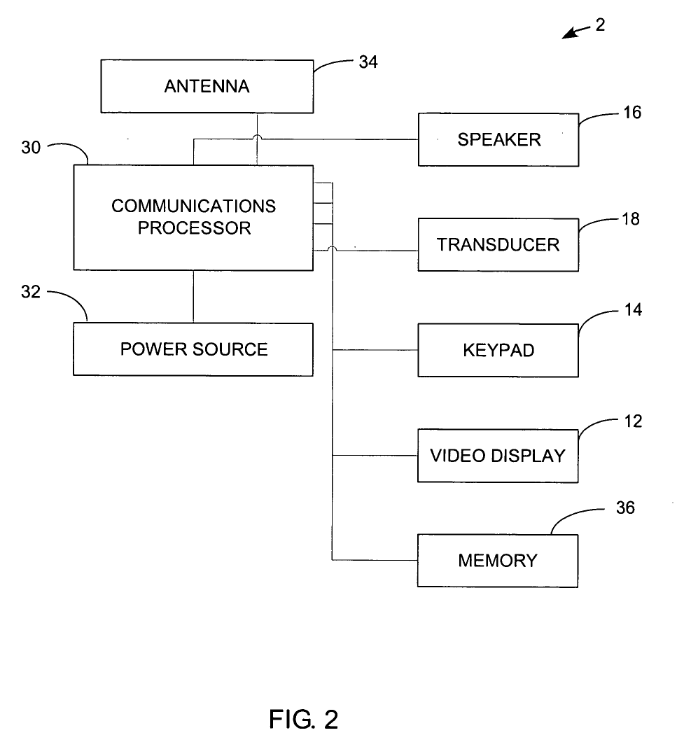

FIG. 2 illustrates a block diagram of some of the operating elements found within the communication device 2. Referring to FIGS. 1 and 2, the communication device 2 includes a communications processor 30, which operates to receive and transmit communication signals through the communication device 2 via an antenna 34. Typically, the entire communication device 2 is powered by some type of power source 32, in most cases this is a rechargeable battery, and may also be powered directly either during a recharge state or just through connection to a power adapter. The communications processor 30 is utilized to operate and control the display 12, a data entry system or the keypad 14, the speaker 16, and the microphone or transducer 18.

The communication device 2 can also include memory 36, which can be controlled by the processor 30, and can be used to store information such as phone numbers, addresses, text messages, and other information desired by the user. The memory 36 can be comprised of flash memory, which needs no additional power to maintain the stored data, or power efficient random access memory (RAM) that requires minimal power, thereby preserving battery life.

The external jack 22 can be provided such that a user can include an earpiece microphone combination to provide hands free listening. The jack 22 bypasses the transducer 18 and speaker 16 when an earpiece/microphone extension is inserted within the jack 22. The user still must operate the communication device 2 within the hand in order to manipulate the keypad 14 and either answer an incoming call or to place an outgoing call, or to enter any other type of data, such as a new telephone number, an address, or place a text message to a desired party. While the jack 22 is connected to an earpiece, the communication device 2 can be programmed to answer automatically, thus allowing hands-free use while driving.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A portable communication device, comprising:
a housing having an operating surface and having an upright phone operating position;
a communications processor, disposed in the housing, operable to receive and transmit a communications signal;
a display, coupled to the communications processor, positioned nearer a lower portion of the operating surface than an upper portion of the operating surface with the housing disposed in the upright phone operating position; and
a keypad, coupled to the communications processor, positioned above the display nearer the upper portion of the operating surface than the lower portion of the operating surface.

2. The portable communication device of claim 1, wherein the housing comprises a back side operable to be held in the upright phone operating position with all four fingers of one hand positioned around the back side of the housing and with a thumb of the one hand comfortably positioned over the keypad on the operating surface.

3. The portable communication device of claim 1, wherein the keypad comprises an alpha-numeric key pad arrangement with readable indicia in an upright orientation with the housing held in the upright phone operating position.

4. The portable communication device of claim 1, wherein the keypad comprises function keys with readable indicia in an upright orientation with the housing held in the upright phone operating position.

5. The portable communication device of claim 1, further comprising a transducer, operatively coupled to the communications processor, to receive an audio input signal to be transmitted by the communications processor.

6. The portable communication device of claim 5, wherein the transducer comprises a microphone positioned adjacent the display at the lower portion of the operating surface.

7. The portable communication device of claim 1, further comprising a speaker operatively coupled to the communications processor operable to respond to a signal received from the communications processor to generate audio sound.

8. The portable communication device of claim 7, wherein the speaker is positioned at the keypad at the upper portion of the operating surface of the housing.

9. The portable communication device of claim 1, further comprising a battery disposed in the housing operable to provide power to the portable communication device.

10. A hand-held portable communication device comprising:
a communications processor operable to receive and transmit communications signals;
a speaker operable to respond to a signal received from the communications processor to generate audio sound;
a transducer operable to respond to an audio input to convert the audio input into an electrical signal to be processed for output by the communications processor;
a display operable to respond to a data signal received from the communications processor to display data; and
a keypad operable to convert input on the keypad into communications signals to be processed by the communications processor and displayed on the display;
the keypad being physically positioned above the data display when held in a user's hand so as to provide operation by a single hand holding the portable communication device and using an opposable digit of the hand so as to allow viewing of the data entry display by the user during use of the keypad.

11. The hand-held portable communication device of claim 10, further comprising an antenna coupled to the communications processor and operable to receive and transmit communications signals.

12. The hand-held portable communication device of claim 10, wherein the keypad comprises an alpha-numeric key pad arrangement with readable indicia in an upright orientation with the portable communication device held in an upright phone operating position.

13. The hand-held portable communication device of claim 10, further comprising a battery, coupled to the communications processor, operable to provide power to the portable communication device.

14. The hand-held portable communication device of claim 10, wherein the transducer comprises a microphone positioned adjacent the display at a lower portion of the portable communication device.

15. The hand-held portable communication device of claim 10, wherein the speaker is positioned at the keypad at an upper portion of the portable communication device.

16. A hand-held portable communication device comprising:
a housing;
processing means, within the housing, for processing communications signals;
speaker means in the housing for generating an audio sound in response to a signal received from the processing means;
microphone means, coupled to the processing means, for generating an audio signal in response to acoustic waves;
display means, located within the housing, for displaying data responsive to a data signal received from the processing means; and
data input means, located within the housing, for inputting and converting input pulses into communications signals to be processed by the processor means and displayed on the display means and is positioned above the display means so as to provide operation by a single hand holding the housing and using an opposable digit of the hand so as to allow viewing of the display means by the user during use of the inputting and converting means.

17. The hand-held portable communication device of claim 16, further comprising means for providing electrical power to the portable communication device.

18. The hand-held portable communication device of claim 16, wherein the speaker means is an earpiece.

19. The hand-held portable communication device of claim 16, further comprising antenna means, coupled to the processor means, for receiving and transmitting electric wave signals to be processed by the processor means.

20. The hand-held portable communication device of claim 16, wherein the data input means comprises a keypad having an alpha-numeric key pad arrangement with readable indicia in an upright orientation with the housing held in an upright phone operating position.

21. The hand-held portable communication device of claim 16, wherein the microphone means is positioned adjacent the display means at a lower portion of the housing with the housing held in an upright phone operating position.

22. The hand-held portable communication device of claim 16, wherein the speaker means is positioned at the data input means at an upper portion of the housing with the housing held in an upright phone operating position.

23. A method for operating a hand-held portable communication device, the method comprising:
holding a portable communication device in an upright phone operating position with one hand of a person having all four fingers disposed around a back side of the portable communication device and a thumb positioned over an upper portion of an operating surface of the portable communication device;
depressing keys of a keypad in the upper portion of the operating face of the portable communication device with the thumb of the one hand comfortably disposed over the keypad; and
viewing readable indicia uprightly oriented in a display defined in a lower portion of the operating face below the keypad with the portable communication device held in the upright phone operating position.

24. The method of claim 23, further comprising the step of communicating with another person with the portable phone having a communications processor coupled to the keypad and the display and operable to receive and transmit communications signals, the communications processor coupled to a speaker and a transducer.
